(19) United States
(12) Patent Application Publication
(10) Pub. No.: US 2026/0274736 A1
(43) Pub. Date: Sep. 17, 2026

(54) FIBER PREFORM WITH LASER WELD VOLUME INCLUDING ULTRAVIOLET ABSORBING CONSTITUENT AND METHOD OF MANUFACTURING THE SAME

(71) Applicant: CORNING INCORPORATED, CORNING, NY (US)

(72) Inventor: Stephan Lvovich Logunov, Corning, NY (US)

(21) Appl. No.: 19/557,341

(22) Filed: Mar. 5, 2026

Related U.S. Application Data
(60) Provisional application No. 63/771,721, filed on Mar. 14, 2025.

(51) Int. Cl. C03B 37/012; C03B 23/207

(52) U.S. Cl. CPC C03B 37/01222; C03B 23/207; C03B 37/0122; C03B 2203/16

(57) ABSTRACT

A fiber preform including in one embodiment: an outer preform cladding through which a fiber longitudinal axis extends; inner preform tubes coupled to an inner cladding surface of the outer preform cladding; first laser weld volumes fusing the inner preform tubes to the outer preform cladding proximate a first preform end; and second laser weld volumes fusing the inner preform tubes to the outer preform cladding proximate a second preform end. The first laser weld volumes and the second laser weld volumes include an oxide that exhibits an ultraviolet absorption tail within a range of from 200 nm to 400 nm. Outside of the first laser weld volumes and the second laser weld volumes, the inner preform tubes and the outer preform cladding are substantially free of the metal oxide. A method of making the fiber preform using ultraviolet wavelength laser emissions.

### CROSS REFERENCE TO RELATED APPLICATIONS

This Application claims the benefit of priority to U.S. Provisional Patent Application Serial Number 63/771721 filed on Mar. 14, 2025, the content of which is relied upon and incorporated herein by reference in its entirety.

### TECHNICAL FIELD

The present disclosure pertains to optical fiber preforms and methods of manufacturing the same and, more particularly, to optical fiber preforms for anti-resonant hollow core optical fibers and a method of making the same using ultraviolet laser welding emissions.

### BACKGROUND

An optical fiber can be utilized to transmit an electromagnetic radiation signal across a distance. In a traditional design, the optical fiber includes a solid core through which the signal transmitted and a solid cladding disposed radially around the solid core. The solid core and the solid cladding have different indices of refraction. The signal thus largely stays confined within the solid core during transmission because of total internal reflection at the interface between the solid core and the solid cladding. The utilization of the solid core limits the speed at which the optical fiber can transmit the signal (e.g., an inherent minimum latency), limits the power of the signal that can be transmitted, imposes a degree of attenuation of the signal, and introduces non-linear effects such as four-wave mixing.

To address the limitations of the solid core based optical fiber, optical fibers with a hollow core have been proposed. With such an optical fiber, there is no solid core but rather a hollow core. Various ways of maintaining the signal within the hollow core have been utilized – one of which is anti-resonance. With anti-resonance, the cladding is engineered with the operating wavelength of the signal in mind to reflect the signal back into the hollow core rather than transmitting through the cladding. An example of such a cladding are hollow tubes that run axially with the transmission axis through the hollow core. The hollow tubes are placed radially around the transmission axis to define the hollow core and have a thickness at which the hollow tubes do not resonate with the signal but rather reflect the signal to maintain the signal within the hollow core. Such optical fibers are typically referred to as anti-resonant hollow core optical fibers or ARFs for short.

Techniques to manufacture ARFs are under development. However, like solid core optical fibers, the techniques typically all include drawing the ARF from a preform that is structurally similar to the AFR but with thicker components. Fabrication of the preform may require precise spatial placement of the preform cladding tubes relative to each other and a surrounding outer cladding. To obtain the precise spatial placement, it has been proposed to fuse the preform cladding tubes and the surrounding outer cladding together. Such fusion has heretofore been achieved using a laser to weld the components, optionally with a metal film preplaced where the weld is to be. A CO₂ laser (10.6 microns wavelength) or a CO laser (around 5 microns wavelength) can be used directly to weld silica since silica is highly absorbing at these wavelength, with welding occurring via heat conduction from the surface to the interface between components. When a metal film is utilized, the metal film is applied via vapor deposition and the glass components are transparent to the laser emission. The metal film absorbs the laser emission, increases in temperature, and conducts heat to the preform components to be fused. The conducted heat causes the preform components to melt. The melted portions then cool and fuse. Alternatively, an open flame has been utilized to fuse the components together.

However, those manufacturing techniques cause several problems. First, adding metal film via vapor deposition is suboptimal in terms of time and expense. Second, the metal of the metal film diffuses into the components of the preform thus altering the composition. The altered composition can negatively affect signal transmission through the ARF drawn from the preform. Third, the CO₂ laser, and to a greater degree the open flame, generate substantial residual stress within the components near where the components are fused. In the context of the CO2 laser, substantial residual stress is generated because the emission from a CO₂ laser has a peak intensity at a wavelength of about 10.6 µm, which is within the mid-infrared range. Silica highly absorbs that wavelength of electromagnetic radiation. Thus, attempted laser welding of glass components via CO₂ generates stress wherever the glass components encounter the emission and not just at the interface between the components where the weld is desired. The residual stress may cause the component to fracture, which may require the preform to be scrapped.

### SUMMARY

The present disclosure addresses those problems with a method of manufacturing the fiber preform that utilizes an interfacial layer between the inner preform tube and the outer preform cladding where the laser weld volume is to be made. The interfacial layer is preferably a soot layer. The interfacial layer preferably includes silica and a dopant that enables the silica to absorb ultraviolet radiation. An ultraviolet (UV) laser then, instead of a CO₂ laser, is used to generate a welding emission that the interfacial layer absorbs. Absorption of the welding emission by the interfacial layer generates a plasma in the interfacial layer and leads to an increase in the temperature of the interfacial layer that causes a decrease in the viscosity of the inner preform tube and the outer preform cladding. A second mechanism in some embodiments is a shift of the UV absorption of the interfacial layer to longer wavelength with the increase of temperature, which leads to additional absorption by the interfacial layer itself at or near the interface region. Upon cooling, a laser weld volume forms that fuses the inner preform tube and the outer preform cladding together. No metal film is used to absorb the welding emission. Thus, the need for vapor deposition and the issue of metal diffusion are avoided. Silica, from which the inner preform tube and the outer preform cladding are made, does not absorb well the ultraviolet wavelength welding emission, unlike when the infrared wavelength generating CO₂ laser is used. Thus, substantial stress around the laser weld volume is avoided.

According to a first aspect of the present disclosure, a fiber preform comprises: (a) a first preform end, a second preform end, and a longitudinal axis extending from the first preform end to the second preform end; (b) an outer preform cladding through which the fiber longitudinal axis extends, the outer preform cladding comprising an inner cladding surface facing and disposed radially around the longitudinal axis; (c) inner preform tubes coupled to the outer preform cladding at the inner cladding surface of the outer preform cladding, each of the inner preform tubes comprising (i) a tube axis extending therethrough parallel to the longitudinal axis of the fiber preform, (ii) an inner tube surface extending radially around the tube axis, and (iii) an outer tube surface facing away from the tube axis, and wherein the inner preform tubes collectively defining a preform core that extends radially from the longitudinal axis and that is tangential to the outer tube surface of each of the inner preform tubes; and (d) first laser weld volumes, each of the first laser weld volumes fusing a different one of the inner preform tubes to the outer preform cladding, wherein, each of the first laser weld volumes comprises an oxide that exhibits an ultraviolet absorption tail within a range of from 200 nm to 400 nm.

According to a second aspect of the present disclosure, the fiber preform of the first aspect is presented, wherein the outer preform and each of the inner preform tubes has a composition comprising SiO₂.

According to a third aspect of the present disclosure, the fiber preform of any one of the first through second aspects is presented, wherein the oxide is a glass.

According to a fourth aspect of the present disclosure, the fiber preform of any one of the first through third aspects is presented, wherein the glass is silica glass with a dopant, the dopant inducing the ultraviolet absorption tail in the silica glass.

According to a fifth aspect of the present disclosure, the fiber preform of the fourth aspect is presented, wherein the dopant is TiO₂, GeO₂, B₂O₃, P₂O₅, or Al₂O₃.

According to a sixth aspect of the present disclosure, the fiber preform of any one of the first through fifth aspects is presented, wherein the fiber preform exhibits a maximum tensile stress of less than or equal to 40 MPa proximate the first laser weld volumes.

According to a seventh aspect of the present disclosure, the fiber preform of any one of the first through sixth aspects is presented, wherein each of the first laser weld volumes is proximate the first preform end.

According to an eighth aspect of the present disclosure, the fiber preform of any one of the first through seventh aspects is presented, wherein the ultraviolet absorption tail is within a range of from 300 nm to 400 nm.

According to a ninth aspect of the present disclosure, the fiber preform of any one of the first through eighth further comprises second laser weld volumes, each of the second laser weld volumes fusing a different one of the inner preform tubes to the outer preform cladding.

According to a tenth aspect of the present disclosure, the fiber preform of the ninth aspect is presented, wherein each of the second end laser weld volumes comprises an oxide that exhibits an ultraviolet absorption tail within a range of from 200 nm to 400 nm.

According to an eleventh aspect of the present disclosure, the fiber preform of the tenth aspect is presented, wherein the first laser weld volumes are proximate the first preform end and the second laser weld volumes are proximate the second preform end.

According to a twelfth aspect of the present disclosure, the fiber preform of the eleventh aspect is presented, wherein outside of the first end laser weld volumes and the second end laser weld volumes, the inner preform tubes and the outer preform cladding substantially free of the oxide.

According to a thirteenth aspect of the present disclosure, a method of manufacturing a fiber preform comprises: a laser welding step comprising directing a welding emission from a laser to an interfacial layer sandwiched between an outer preform cladding of a preform workpiece and an inner preform tube of the preform workpiece, wherein (i) the welding emission comprises a wavelength of peak intensity, (ii) the interfacial layer is more absorptive of the wavelength of peak intensity than both the outer perform cladding and the inner preform tube, and (iii) during the laser welding step, the absorption of the welding emission by the interfacial layer generates a plasma that increases temperature and reduces viscosity of one or more of the outer preform cladding and the inner preform tube sufficiently for a laser weld volume to form that fuses the outer preform cladding and the inner preform tube together.

According to a fourteenth aspect of the present disclosure, the method of the thirteenth aspect is presented, wherein the wavelength of peak intensity of the welding emission is within a range of from 200 nm to 400 nm.

According to a fifteenth aspect of the present disclosure, the method of any one of the thirteenth through fourteenth aspects is presented, wherein the interfacial layer is a glass layer or a soot layer.

According to a sixteenth aspect of the present disclosure, the method of the fifteenth aspect is presented, wherein the glass layer or the soot layer comprises silica and a dopant, the dopant inducing an ultraviolet absorption tail in the silica, the ultraviolet absorption tail within a range of from 200 nm to 400 nm.

According to a seventeenth aspect of the present disclosure, the method of the sixteenth aspect is presented, wherein the dopant is one or more of TiO₂, GeO₂, Al₂O₃, P₂O₅, and B₂O₃.

According to an eighteenth aspect of the present disclosure, the method of the seventeenth aspects is presented, wherein the glass layer or the soot layer comprises (i) TiO₂ within a range of from 1.0 wt% to 20.0 wt% and (ii) silica within a range of from 80.0 wt% and 99 wt%.

According to a nineteenth aspect of the present disclosure, the method of any one of the thirteenth through eighteenth aspects further comprises: (a) a curable coating step preceding the laser welding step, the curable coating step comprising coating a curable mixture onto one or more of an outer tube surface of the inner preform tube and an inner cladding surface of the outer preform cladding to form a curable coating, the curable mixture comprising a precursor of the interfacial layer in a powder form and an ultraviolet-curable adhesive; (b) a curing step comprising directing ultraviolet electromagnetic radiation onto the curable coating disposed upon the one or more of the outer tube surface and the inner cladding surface to form a sinterable layer; and (c) a sintering step comprising subjecting the sinterable layer, while disposed upon the one or more of the outer tube surface and the inner cladding surface, to a sintering temperature to form the interfacial layer.

According to a twentieth aspect of the present disclosure, the method of the nineteenth aspect is presented, wherein the precursor of the interfacial layer comprises silica.

According to a twenty-first aspect of the present disclosure, the method of the twentieth aspect is presented, wherein the precursor of the interfacial layer comprises the silica with a dopant.

According to a twenty-second aspect of the present disclosure, the method of any one of the thirteenth through eighteenth aspects further comprises: (a) an evaporable coating step preceding the laser welding step, the evaporable coating step comprising coating an evaporable mixture onto one or more of an outer tube surface of the inner preform tube and an inner cladding surface of the outer preform cladding to form a sinterable layer, the evaporable mixture comprising a precursor of the interfacial layer in a powder form, a dispersant, a binder, and a solvent; and (b) a sintering step comprising subjecting the sinterable layer to a sintering temperature while disposed upon the one or more of the outer tube surface and the inner cladding surface, thus forming the soot layer.

According to a twenty-third aspect of the present disclosure, the method of the twenty-second aspect is presented, wherein the precursor of the interfacial layer comprises silica.

According to a twenty-fourth aspect of the present disclosure, the method of the twenty-third aspect is presented, wherein the precursor of the interfacial layer comprises the silica with a dopant.

According to a twenty-fifth aspect of the present disclosure, the method of any one of the thirteenth through twenty-fourth aspects is presented, wherein the interfacial layer exhibits a coefficient of thermal expansion that is less than or equal to 1 ppm/K at 20° C.

According to a twenty-sixth aspect of the present disclosure, the method of the twenty-fifth aspect is presented, wherein the coefficient of thermal expansion that the interfacial layer exhibits is less than or equal to 5 ppb/K at 20°C.

According to a twenty-seventh aspect of the present disclosure, the method of any one of the thirteenth through twenty-sixth aspects is presented, wherein the interfacial layer comprises a layer thickness than is within a range of from 1 µm to 300 µm.

According to a twenty-eighth aspect of the present disclosure, the method of any one of the thirteenth through twenty-seventh aspects further comprises a translating step comprising translating the preform workpiece relative to the laser during the laser welding step so that the laser weld volume extends along a weld length, wherein, the interfacial layer extends along a layer length before performance of the laser welding step, the layer length substantially matching the weld length.

According to a twenty-ninth aspect of the present disclosure, the method of the twenty-eighth aspect is presented, wherein the weld length is parallel to the longitudinal axis.

According to a thirtieth aspect of the present disclosure, the method of any one of the thirteenth through twenty-ninth aspects further comprises an assembly step comprising bringing the outer preform cladding and the inner preform tube together so that the interfacial layer is sandwiched therebetween, thus forming the preform workpiece.

According to a thirty-first aspect of the present disclosure, the method of the thirtieth aspect is presented, wherein (i) the assembly step comprises bringing a plurality of the inner preform tubes together with the outer preform cladding, and (ii) the interfacial layer is sandwiched between each of the inner preform tubes and the outer preform cladding.

According to a thirty-second aspect of the present disclosure, the method of the thirty-first aspect further comprises repeating the laser welding step to form a plurality of the laser weld volumes, each of the laser weld volumes fusing a different one of the inner preform tubes to the outer preform cladding.

According to a thirty-third aspect of the present disclosure, the method of any one of the thirteenth through thirty-second aspects is presented, wherein during the laser welding step, the laser emits the welding emission with an average power within a range of from 2 W to 60 W and as pulses with a frequency of less than 5 MHz and a pulse duration within a range of from 1 ps to 20 ns.

According to a thirty-fourth aspect of the present disclosure, an anti-resonant hollow core optical fiber drawn from the fiber preform of any one of the first through twelfth aspects or from a fiber preform made pursuant to the method of any one of the thirteenth through thirty third aspects.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

In the Drawings:

FIG. 1 is a perspective view of a fiber preform of the present disclosure, illustrating inner preform tubes fused to an inner cladding surface of an outer preform cladding;

FIG. 2 is an elevation view of the fiber preform, illustrating the inner preform tubes evenly spaced around a longitudinal axis of the fiber preform to define a preform core at a core radius from the longitudinal axis;

FIG. 3 is an elevation view of a cross section of the fiber preform taken through line III-III of FIG. 2, illustrating a first laser weld volume fusing one of the inner preform tubes and the outer preform cladding together proximate a first preform end of the fiber preform and a second laser weld volume fusing the inner preform tube and the outer preform cladding together proximate a second preform end of the fiber preform;

FIG. 4 is a schematic diagram of a method of manufacturing the fiber preform, illustrating an assembly step and a laser welding step, among others;

FIG. 5 is like FIG. 3 but this time illustrating the laser welding step with a laser emitting a welding emission onto a soot layer sandwiched between the inner preform tube of a preform workpiece and the outer preform cladding while a translating step is being conducted translating the preform workpiece relative to the laser;

FIG. 6 are perspective and elevation views of a curable coating step and a curing step of the method, illustrating, for the curable coating step, a curable mixture being applied to an outer tube surface of one of the inner preform tubes to form a curable coating and, for the curing step, an ultraviolet source emitting ultraviolet electromagnetic radiation to cure the curable coating into a sinterable coating;

FIG. 7 is a perspective view of an evaporable coating step of the method, illustrating an evaporable mixture being applied to the outer tube surface of one of the inner preform tubes to form a sinterable coating;

FIG. 8 is an elevation view of a sintering step of the method, illustrating one of the inner preform tubes with the sinterable coatings placed within a sintering furnace to increase temperature that densifies the sinterable coating into the soot layer;

FIGS. 9 and 10, pertaining to Example 1, are images of a laser weld volume fusing part of outer preform cladding and an inner preform tube together;

FIG. 11, pertaining to Example 2, is an image while under birefringence analysis of a laser weld volume fusing two blocks of glass material together, illustrating a lack of tensile stress at an interface proximate the laser weld volume;

FIG. 12, pertaining to Example 3, is an image while under birefringence analysis of a laser weld volume fusing two blocks of glass material together, illustrating a lack of tensile stress at an interface proximate the laser weld volume and also illustrating the laser weld volume extending upward into the top block of glass material, which was a consequence of the plasma that the welding emission generated chasing the welding emission toward the source;

FIGS. 13 and 14, pertaining to Example 4, are images showing a laser weld volume fusing a flat glass piece and a curved glass piece together.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

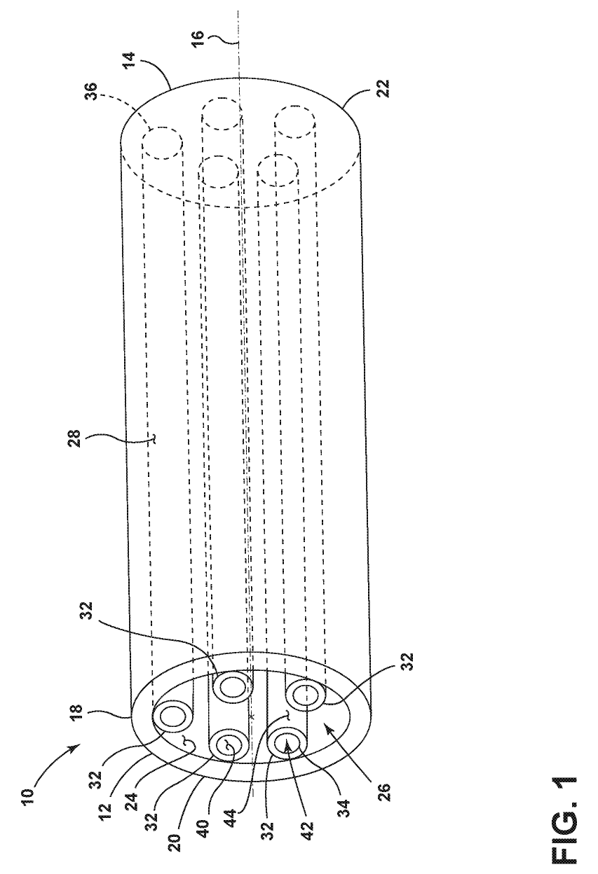

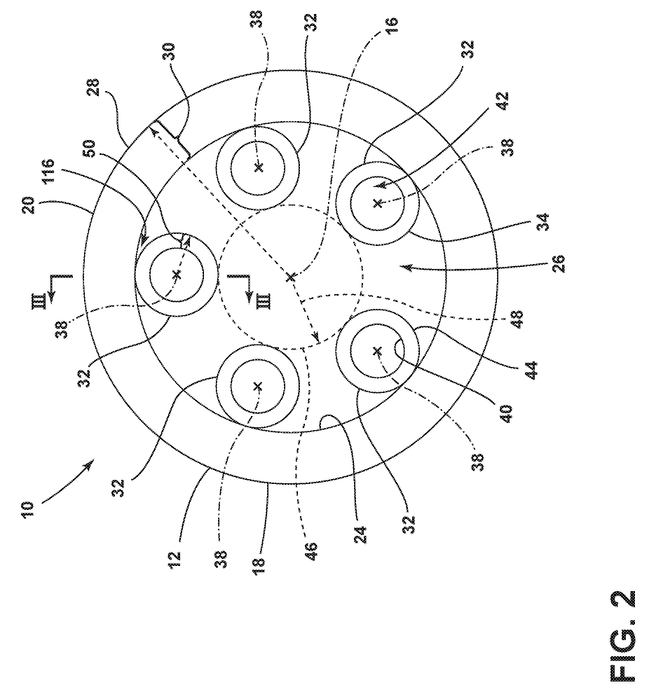

Referring to FIGS. 1-2, a fiber preform 10 is herein disclosed. The fiber preform 10 includes a first preform end 12 and a second preform end 14. The first preform end 12 and the second preform end 14 face in opposite directions. The fiber preform 10 further includes a longitudinal axis 16 that extends from the first preform end 12 to the second preform end 14.

The fiber preform 10 further includes an outer preform cladding 18. The longitudinal axis 16 extends through the outer preform cladding 18. The outer preform cladding 18 has a first cladding end 20 that may define at least in part the first preform end 12. The outer preform cladding 18 has a second cladding end 22 that may define at least in part the second preform end 14. The outer preform cladding 18 provides an inner cladding surface 24 that is disposed radially around the longitudinal axis 16. The inner cladding surface 24 faces the longitudinal axis 16. The inner cladding surface 24 defines a cladding interior 26 through which the longitudinal axis 16 extends. The inner cladding surface 24 can at least partially define the longitudinal axis 16 of the fiber preform 10. The outer preform cladding 18 further includes an outer cladding surface 28 that faces away from the longitudinal axis 16. The outer preform cladding 18 further includes a cladding thickness 30 (see FIG. 2) that is measured radially relative to the longitudinal axis 16 between the inner cladding surface 24 and the outer cladding surface 28. In embodiments, the cladding thickness 30 is within a range of from 3 mm to 40 mm. For example, the cladding thickness 30 can be 3 mm, 5 mm, 7 mm, 10 mm, 15 mm, 20 mm, 25 mm, 30 mm, 35 mm, 40 mm, or within any range bound by any two of those values (e.g., from 5 mm to 15 mm, from 15 mm to 30 mm, and so on). The cladding thickness 30 could be less than 3 mm or greater than 40 mm, however – the provided values are just exemplary.

The fiber preform 10 further includes inner preform tubes 32. The inner preform tubes 32 are at least partially disposed within the cladding interior 26 of the outer preform cladding 18. As will be discussed in greater detail herein, the inner preform tubes 32 are coupled to the outer preform cladding 18 at the inner cladding surface 24. Each of the inner preform tubes 32 has a first tube end 34 that may define at least in part the first preform end 12. Each of the inner preform tubes 32 has a second tube end 36 that may define at least in part the second preform end 14. Each of the inner preform tubes 32 has a tube axis 38 extending therethrough that is parallel to the longitudinal axis 16 of the fiber preform 10. Each of the inner preform tubes 32 provides an inner tube surface 40 that is disposed radially around the tube axis 38 thereof. The inner tube surface 40 defines a tube interior 42 through which the tube axis 38 extends. Each of the inner preform tubes 32 provides an outer tube surface 44 that faces away from the tube axis 38 thereof. The inner tube surface 40 and the outer tube surface 44 of each of the inner preform tubes 32 can extend from the tube axis 38 thereof at constant radiuses (not separately illustrated). The inner preform tubes 32 collectively define a preform core 46. The preform core 46 extends radially around the longitudinal axis 16 at a core radius 48. The preform core 46 is tangential to the outer tube surface 44 of each of the inner preform tubes 32. The inner preform tubes 32 may be equidistantly spaced from each other.

Each of the inner preform tubes 32 has a tube thickness 50, which may all be the same. The tube thickness 50 is measured radially relative to the tube axis 38 between the inner tube surface 40 and the outer tube surface 44. In embodiments, the cladding thickness 30 is greater than the tube thickness 50. In embodiments, the tube thickness 50 is within a range of from 0.5 mm to 2.0 mm. For example, the tube thickness 50 can be 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, or within any range bound by any two of those values (e.g., from 0.7 mm to 1.5 mm, from 0.8 mm to 1.6 mm, and so on). The tube thickness 50 can be less than 0.5 mm or greater than 2.0 mm, however – those values are merely exemplary.

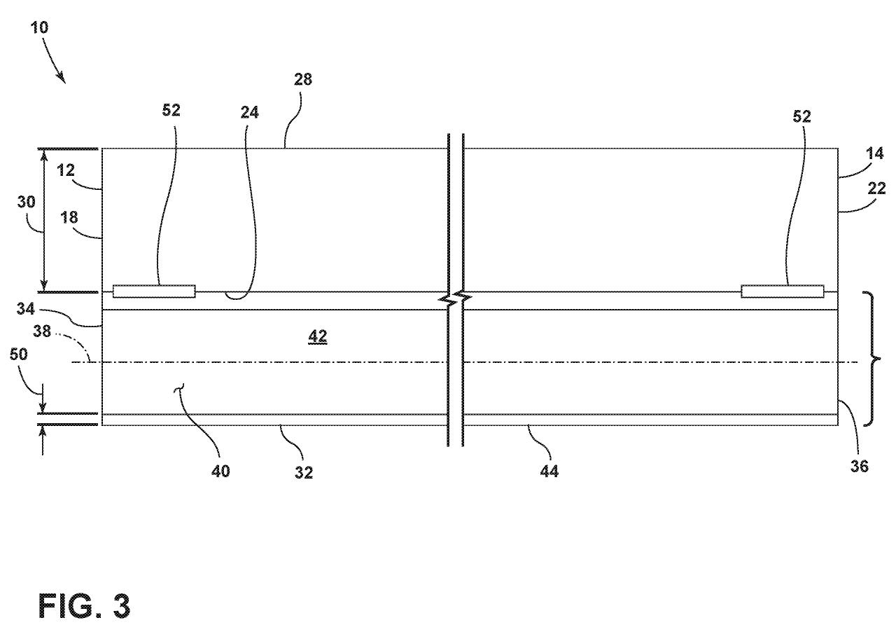

Referring now additionally to FIG. 3, the depicted embodiment of fiber preform 10 further includes first laser weld volumes 52 and, optionally but preferably, second laser weld volumes 54. Each of the first laser weld volumes 52 fuse a different one of the inner preform tubes 32 to the outer preform cladding 18 proximate the first preform end 12. Similarly, each of the second laser weld volumes 54 fuse a different one of the inner preform tubes 32 to the outer preform cladding 18 proximate the second preform end 14. In embodiments, the first laser weld volumes 52 are located at positions away from, or not proximate to, first preform end 12, such as at an axial position along the longitudinal axis 16 within cladding interior 26 away from first preform end 12, and/or the second laser weld volumes 54 are located at positions away from, or not proximate to, second preform end 14, such as at an axial position along the longitudinal axis 16 within cladding interior 26 away from second preform end 14.

Each of the inner preform tubes 32 and the outer preform cladding 18 have a glass composition. Examples of suitable glass compositions include one or more of silica, fused silica, doped silica, fluorine-doped borosilicate glass, borosilicate glass, soda-lime glass, and aluminosilicate glass.

Each of the first laser weld volumes 52 and each of the second laser weld volumes 54 includes material from an interfacial layer 112 that exhibits an ultraviolet absorption tail within a range of from 200 nm to 400 nm. In some embodiments, the ultraviolet absorption tail is within a range of from 250 nm to 400 nm, or in a range from 300 nm to 400 nm, or in a range from 350 nm to 400 nm. The interfacial layer 112 is preferably an oxide, and more preferably silica with a dopant, where the dopant induces ultraviolet absorption of the silica. As will be further discussed below, the presence of the interfacial layer during the manufacturing of the fiber preform 10 facilities the use of a laser 110 that generates a welding emission 108 having a wavelength in the range of the UV absorption in order to form the first laser weld volumes 52 and/or the second laser weld volumes 54. The welding emission 108 can include laser radiation with a wavelength matching absorption of the interfacial layer 112 and within transparent window of fused silica substrate. Preferably, outside of each of the first laser weld volumes 52 and the second laser weld volumes 54, the inner preform tubes 32 and the outer preform cladding 18 are substantially free of the material of the interfacial layer 112. The presence of the interfacial layer 112 helps define the location of the first laser weld volumes 52 and/or the second laser weld volumes 54. In embodiments, the dopant in silica is one or more of TiO₂, GeO₂, Al₂O₃, P₂O₅, and B₂O₃. A particularly useful composition for the interfacial layer 112 is (i) TiO₂ within a range of from 1.0 wt% to 20.0 wt% and (ii) silica within a range of from 80.0 wt% and 99 wt%. Such a composition is commercially available as Corning® ULE® (Corning Inc., Corning, NY USA). In one embodiment, the interfacial layer 112 is a glass layer. In another embodiment, the interfacial layer 112 is a soot layer.

In embodiments, the fiber preform 10 exhibits a maximum tensile stress of less than or equal to 40 MPa within or proximate the first laser weld volumes 52 and/or the second laser weld volumes 54. For example, the maximum tensile stress can be 0 MPa, 5 MPa, 10 MPa, 15 MPa, 20 MPa, 25 MPa, 30 MPa, 35 MPa, 40 MPa, or within any range bound by any two of those values (e.g., from 0 MPa to 40 MPa, from 20 MPa to 30 MPa, and so on). The maximum tensile stress can be determined via birefringence analysis. For purposes of the present disclosure, tensile stress refers to tensile stress in a region located within 1000 microns of the interface between the two welded parts.

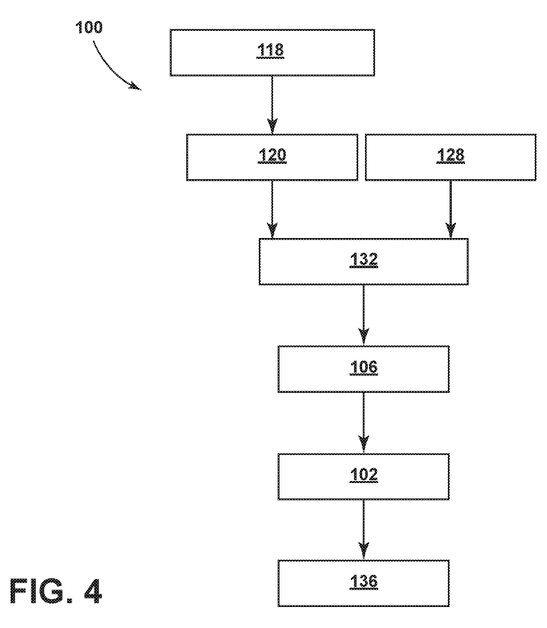

Referring now to FIGS. 4-8, a method 100 of manufacturing the fiber preform 10 is further disclosed herein. The method 100 includes a laser welding step 102. In embodiments, the method 100 can further include an assembly step 106, among others, as will be further described.

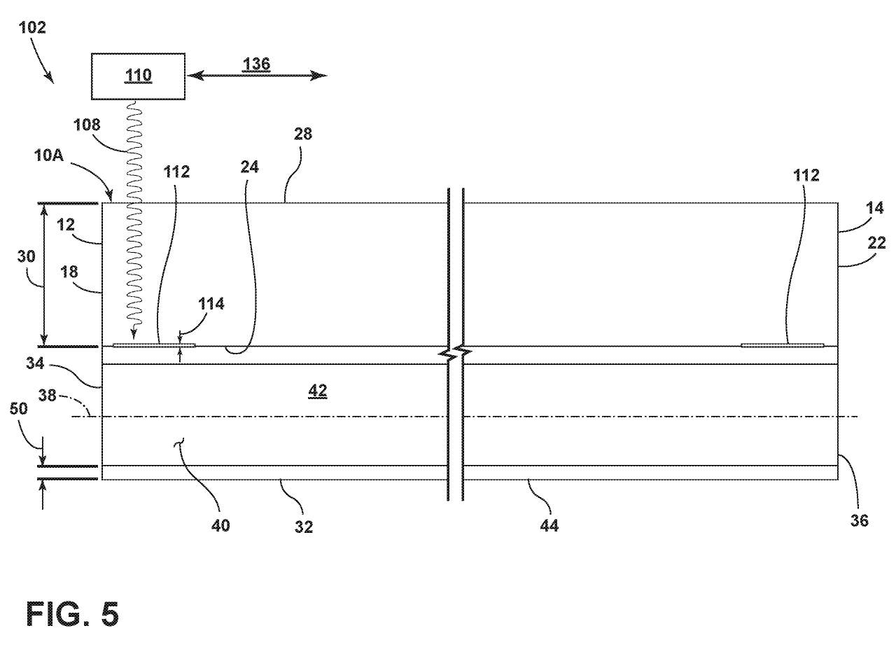

The laser welding step 102 (see FIG. 5) includes directing a welding emission 108 from a laser 110 to an interfacial layer 112 sandwiched between an outer preform cladding 18 of a preform workpiece 10A and one of the inner preform tubes 32 of the preform workpiece 10A. The preform workpiece 10A is the predecessor to the fiber preform 10, and begins a first performance of the laser welding step 102 to generate a laser weld volume 52 52 (e.g., the first laser weld volumes 52) fusing a first one of the inner preform tubes 32 to the outer preform cladding 18. After all of the inner preform tubes 32 have been so fused, the preform workpiece 10A has been transformed into the fiber preform 10.

The welding emission 108 has a wavelength of peak intensity. In embodiments, the wavelength of peak intensity of the welding emission 108 is within a range of from 200 nm to 400 nm. For example, the wavelength of the peak intensity can be 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, or within any range bound by any two of those values (e.g., from 290 nm to 360 nm, from 300 nm to 350 nm, from 350 nm to 400 nm, and so on). In short, in these embodiments, the laser 110 is an ultraviolet laser 110.

The interfacial layer 112 is more absorptive of the wavelength of peak intensity than both the outer preform cladding 18 and the inner preform tube 32. In embodiments in which the interfacial layer 112 is silica with a dopant, this is due to the presence of the dopant in the the silica of the interfacial layer 112. The dopant, as mentioned, induces ultraviolet absorption in the silica, which has an ultraviolet absorption tail within a range of from 200 nm to 400 nm, or within a range of from 250 nm to 400, or within a range from 300 nm to 400 nm, or within a range from 350 nm to 400 nm. Stated another way, by ultraviolet absorption tail is meant that the interfacial layer absorbs ultraviolet radiation but absorbance falls off as wavelength increases toward the visible spectrum, eventually reaching an absorbance more aligned with silica. The wavelength of peak intensity of the welding emission 108 is selected such that absorption of the welding emission 108 by the interfacial layer 112 is greater than absorption of the welding emission 108 by either the inner preform tubes 32 or outer preform cladding 18. In some embodiments, one or more of the inner preform tubes 32 and the outer preform cladding 18 does/do not absorb the wavelength of peak intensity of the welding emission 108. For example, the transmission, per 10 mm thickness as measured by a spectrophotometer, of one or more of the inner preform tubes 32 and outer preform cladding 18 is greater than 90%, or greater than 95%, or greater than 98%, or greater than 99%, or greater than 99.5%, or greater than 99.9% at the wavelength of peak intensity of the welding emission 108.

During the laser welding step 102, the absorption of the welding emission 108 by the interfacial layer 112 generates a plasma within the interfacial layer 112. The plasma, sandwiched between the outer preform cladding 18 and the inner preform tube 32, increases temperature and reduces viscosity of not only the interfacial layer 112 but also of one or more of the outer preform cladding 18 and the inner preform tubes 32. The increase in temperature and reduction in viscosity is sufficient to form, upon cooling, the laser weld volume(s) 52 that fuses the outer preform cladding 18 and the inner preform tube 32 together.

In embodiments, the interfacial layer 112 exhibits a coefficient of thermal expansion that is less than or equal to 1 ppm/K at 20° C or even less than or equal to 5 ppb/K at 20°C. For example, the coefficient of thermal expansion that the interfacial layer 112 exhibits can be 1 ppb/K, 5 ppb/K, 10 ppb/K, 50 ppb/K, 100 ppb/K, 500 ppb/K, 1 ppm/K, or within any range bound by any two of those values (e.g., from 1 ppb/K to 1 ppm/K, from 5 ppb/K to 100 ppb/K, and so on). The coefficient of thermal expansion can be determined via ASTM E228.

Such a low coefficient of thermal expansion is beneficial because the interfacial layer 112 is disposed between the outer preform cladding 18 and the inner preform tube 32 of the preform workpiece 10A and forms at least part of the laser weld volume 52 (e.g., the first laser weld volumes 52) of the fiber preform 10. If the interfacial layer 112 were to change dimensionally to a large degree in response to a temperature change, then the interfacial layer 112 could cause one or more of the outer preform cladding 18 and the inner preform tube 32 to crack during the laser welding step 102 or after as materials cool.

The interfacial layer 112 has a layer thickness 114. The layer thickness 114 is measured radially from the tube axis 38 of the inner preform tube 32 upon which the interfacial layer 112 is disposed. In embodiments, the layer thickness 114 is within a range of from 1 µm to 300 µm. For example, the layer thickness 114 can be 1 µm, 5 µm, 10 µm, 25 µm, 50 µm, 75 µm, 100 µm, 125 µm, 150 µm, 175 µm, 200 µm, 225 µm, 250 µm, 275 µm, or within any range bound by any two of those values (e.g., from 10 µm to 50 µm, from 25 µm to 175 µm, and so on. The layer thickness 114 could be greater than 300 µm or less than 1 µm – those values are merely exemplary.

The interfacial layer 112 provides an added benefit of filling a gap 116 (see FIG. 2) that might otherwise exist between the outer preform cladding 18 and the inner preform tube 32. The outer tube surface 44 of the inner preform tube 32 has a radius that is smaller than a radius of the inner cladding surface 24 of the outer preform cladding 18. Thus, without the soot layer 112 sandwiched therebetween, the outer tube surface 44 and the inner cladding surface 24 would touch only at a line parallel to the longitudinal axis 16. Along that line is where the first laser weld volumes 52 and the second laser weld volumes 54 are located, with the gap 116 existing on both sides of that line. The interfacial layer 112 fills some of that gap 116 (e.g., up to a gap distance of about 10 µm). Therefore, the first laser weld volumes 52 and the second laser weld volumes 54 form more easily within that gap 116 during the laser welding step 102. The resulting fusion is stronger due to the first laser weld volumes 52 and the second laser weld volumes 54 extending outward past the line into the gap 116. Simultaneously, the layer thickness 114 is thin enough and the coefficient of thermal expansion of the interfacial layer 112 is low enough that stress introduced by the welding emission 108 within the outer preform cladding 18 and the inner preform tube 32 is relatively low (compared to welding with a CO₂ laser).

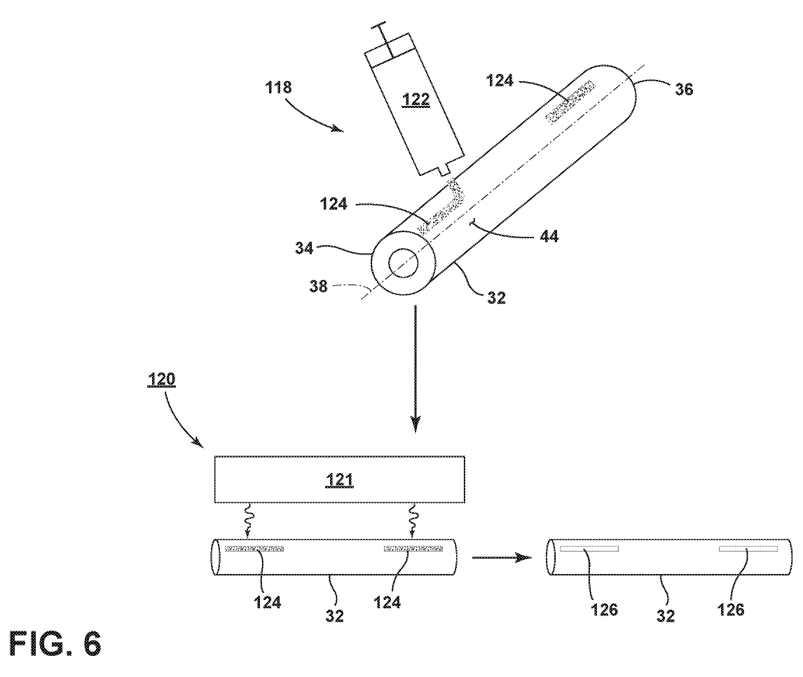

Now several ways to form the interfacial layer 112 are discussed. In embodiments, the method 100 further includes a curable coating step 118 (see FIG. 6) and a curing step 120, both of which occur before the laser welding step 102. The curable coating step 118 includes coating a curable mixture 122 onto one or more of the outer tube surface 44 or the inner cladding surface 24. The curable mixture 122 includes a precursor for the interfacial layer 112. and an ultraviolet-curable adhesive. The precursor for the interfacial layer 112 is preferably in powder form. The composition of the precursor has the same composition as the composition of interfacial layer 112. Alternatively, the precursor includes a combination of one or more components that combine to form interfacial layer 112. For example, the precursor of the interfacial layer 112 may include a combination of silica in powder form and a dopant (e.g., TiO₂) in powder form. The weight percentage of the precursor of the interfacial layer 112 in the curable mixture 122 can range from 30 wt% to 70 wt%, with the balance of curable mixture 122 being the ultraviolet-curable adhesive. In powder form, in one embodiment, Corning ULE® has a specific surface area of 10 m²/g. Suitable examples of the ultraviolet-curable adhesive include a cationic epoxy adhesive, an acrylic adhesive, and a thiolene adhesive. Choice of the ultraviolet-curable adhesive can be a function of the desired viscosity and surface tension of the curable mixture 122, as well as cladding thickness 30 and tube thickness 50, shelf-life stability, and the preferred rate of curing (see next paragraph). The result is a curable coating 124. The curable mixture 122 can be applied in one of any number of ways.

The curing step 120 includes directing ultraviolet electromagnetic radiation onto the curable coating 124. The ultraviolet electromagnetic radiation can be generated, not necessarily by the laser 110, but alternatively by a lower intensity UV source 121 such as a UV-LED (e.g., 365 nm) or an Hg-arc lamp (e.g., 200 mW/cm² for 30 seconds). The ultraviolet electromagnetic radiation causes the ultraviolet-curable adhesive in the curable coating 124 to cure, thus forming a sinterable coating 126.

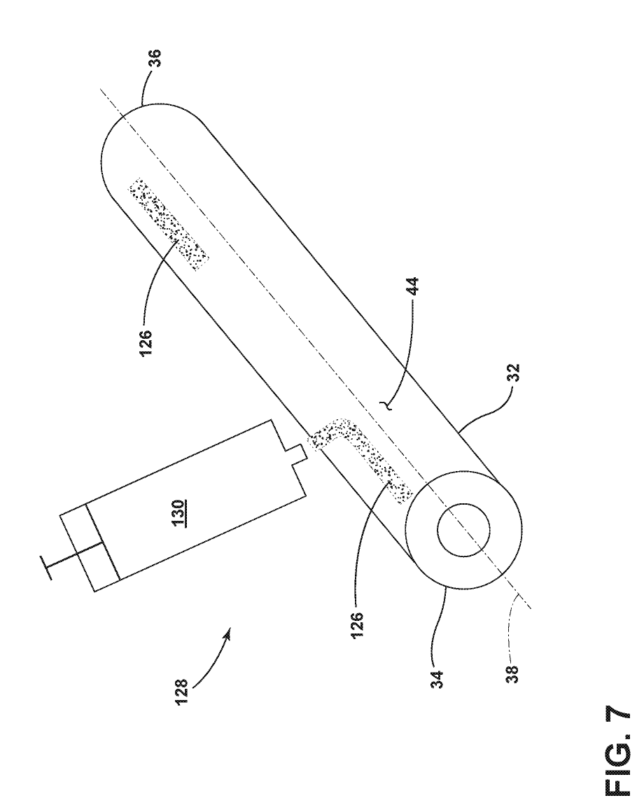

In other embodiments, the method 100 includes an evaporable coating step 128 (see FIG. 7), which occurs before the laser welding step 102. The evaporable coating step 128 includes coating an evaporable mixture 130 onto one or more of the outer tube surface 44 of the inner cladding surface 24 to form another version of the sinterable coating 126. The evaporable mixture 130 includes a precursor for the interfacial layer 112, along with a dispersant, a binder, and a solvent. The precursor for the interfacial layer 112 is preferably in powder form. The composition of the precursor has the same composition as the composition of interfacial layer 112. Alternatively, the precursor includes a combination of one or more components that combine to form interfacial layer 112. For example, the precursor of the interfacial layer 112 may include a combination of silica in powder form and a dopant (e.g., TiO₂) in powder form. Suitable dispersants include triethanolamine, polyester/polyamine copolymers (e.g., Hypermer KD-1 from Croda, East Yorkshire, UK), among other options. Suitable binders include organic binders such methylcellulose, methylcellulose derivatives, polyvinyl butyral, dibutyl phthalate, polyalkyl carbonate (e.g., polybutylene carbonate), acrylic polymers, polyesters, and silicones, among other options. Suitability of the solvent can depend on solubility of the binder. Example solvents include, water, methyl ethyl ketone, toluene, tetrahydrofuran, and acetone. The weight percentage of the dispersant in the evaporable mixture 130 may range from 0.5 wt% to 5 wt% relative to solids loading. The weight percentage of the binder may range from 2.5 wt% to 7.5 wt% relative to solids loading. The weight percentage of the precursor of the interfacial layer 112 can range from 10 wt% to 50 wt%. For example, weight percentage of the of the precursor can be 10 wt%, 15 wt%, 20 wt%, 25 wt%, 30 wt%, 35 wt%, 40 wt%, 45 wt%, 50 wt%, or within any range bound by any two of those values (e.g., from 15 wt% to 25 wt%, from 20 wt% to 40 wt%, and so on).

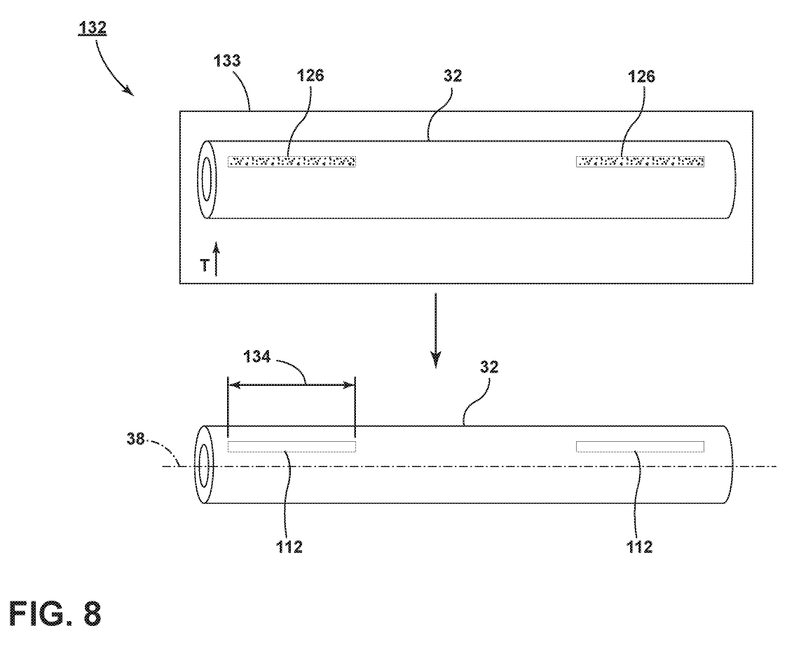

The method 100 further includes a sintering step 132 (see FIG. 8). The sintering step 132 includes subjecting the sinterable coating 126 to a sintering temperature, such as within a sintering furnace 133. While the sinterable coating 126 raises in temperature, the solvent, if present, evaporates. The binder or adhesive, whichever is present, initially largely remains and keeps the shape of the sinterable coating 126. As the temperature continues to rise, the adhesive or binder (whichever is present) burns out, leaving the precursor of the interfacial layer 112, but still maintaining shape. At the sintering temperature, the precursor of the interfacial layer densifies to form the interfacial layer 112. The interfacial layer 112 is a glass layer or a soot layer. The interfacial layer 112 can be formed along a layer length 134 parallel to the tube axis 38 or cladding axis, depending on whichever of the inner preform tube 32 and the outer preform cladding 18 the interfacial layer 112 was applied. During sintering, the density of the precursor to the interfacial layer 112 increases from about 0.2-0.3 g/cm³ in an unsintered state, to about 1.5-1.8 g/cm³ in a partially sintered state, to about 2.3-2.4 g/cm³. Preferably densities for the interfacial layer 112 are in a range from 1.8 g/cm³ to 2.4 g/cm³.

After the interfacial layer 112 is formed on one of the outer preform cladding 18 and the inner preform tube, the preform workpiece 10A is to be assembled in anticipation of the performance of the laser welding step 102. In embodiments then, the method 100 further includes the assembly step 106. During the assembly step 106, the outer preform cladding 18 and the inner preform tube 32 are brought together so that the interfacial layer 112 is sandwiched therebetween. The laser welding step 102 can then be performed. The assembly step 106 can include bringing a plurality of the inner preform tubes 32 together with the outer preform cladding 18. There is an interfacial layer 112 sandwiched between each of the plurality of inner preform tubes 32 and the outer preform cladding 18. The method 100 can then include repeating the laser welding step 102 to form a plurality of the laser weld volumes 52, each of which fuses a different one of the inner preform tubes 32 to the outer preform cladding 18.

A variety of parameters can be manipulated concerning the laser 110 for the welding emission 108. In embodiments, the laser 110 emits the welding emission 108 with an average power within a range of from 2 W to 60 W. For example, the average power can be 2 W, 5 W, 10 W, 15 W, 20 W, 25 W, 30 W, 35 W, 40 W, 45 W, 50 W, 55 W, 60 W, or within any range bound by any two of those values (e.g., from 20 W to 40 W, from 25 W to 50 W, and so on). The average power could be less than 2 W or greater than 60 W, however.

In embodiments, the laser 110 emits the welding emission 108 as pulses with a frequency within a range of from 0.1 MHz to 10 MHz. For example, the frequency can be 0.1 MHz, 0.5 MHz, 1.0 MHz, 2.0 MHz, 3.0 MHz, 4.0 MHz, 5.0 MHz, 6.0 MHz, 7.0 MHz, 8.0 MHz, 9.0 MHz, 10 MHz, or within any range bound by any two of those values (e.g., from 4.0 MHz to 9.0 MHz, from 0.1 MHz to 3.0 MHz, and so on).

In embodiments, each pulse has a pulse duration within a range of from 1 ps to 20 ns. For example, the pulse duration can be 1 ps, 5 ps, 10 ps, 50 ps, 100 ps, 500 ps, 1 ns, 5 ns, 10 ns, 15 ns, 20 ns or within any range bound by any two of those values (e.g., from 5 ps to 50 ps, from 100 ps to 5 ns, and so on). Pulse durations outside of the stated ranges are envisioned.

The general approach of the laser welding step 102 is to utilize lower power but higher repetition of pulses, compared to other laser welding approaches. The laser ablation threshold for glass is generally within a range of from 100 J/cm² to 1,000 J/cm². The welding emission 108, due to the combination of relatively low power and relatively short pulse duration, is well below that laser ablation threshold. More particularly, the energy density for each pulse during the welding emission 108 can be less than 5 J/cm² or even less than 1 J/cm². Despite the relatively low energy density, the relatively high frequency of the pulses renders the welding emission 108 sufficient to form a plasma at the interfacial layer 112. Each subsequent pulse induces higher temperature at and around the interfacial layer 112 and into material of the inner preform tube 32 and/or outer preform cladding 18, generally in the direction into the path of the welding emission 108 (e.g., toward the laser 110) because the plasma itself highly absorbs the welding emission 108. Silica doped with titanium dioxide (TiO₂) for example has weak absorption at 355 nm but is still more absorptive than silica without TiO₂. As temperature at the interfacial layer 112 is raised due to absorption of the welding emission 108, the adsorption UV tail shifts to longer wavelengths and temperature rises with each subsequence pulse leading to high temperatures and further plasma formation.

In embodiments, the method 100 further includes a translating step 136 (see FIG. 5). The translating step 136 occurs simultaneously or sequentially with the laser welding step 102. The translating step 136 includes translating the preform workpiece 10A relative to the laser 110 during the laser welding step 102. The welding emission 108 is directed onto the interfacial layer 112 along the layer length 134. The result is that the laser weld volume 52 extends along a weld length 138 – the weld length 138 generally matching layer length 134. The weld length 138 can be parallel to the longitudinal axis 16 of the fiber preform 10. In embodiments, during the translating step 136, the translating occurs at a translation rate within a range of from 0.1 mm/s to 10 mm/s. For example, the translation rate can be 0.1 mm/s, 0.5 mm/s, 1.0 mm/s, 1.5 mm/s, 2.0 mm/s, 2.5 mm/s, 3.0 mm/s, 3.5 mm/s, 4.0 mm/s, 4.5 mm/s, 5.0 mm/s, 5.5 mm/s, 6.0 mm/s, 6.5 mm/s, 7.0 mm/s, 7.5 mm/s, 8.0 mm/s, 8.5 mm/s, 9.0 mm/s, 9.5 mm/s, 10 mm/s, or within any range bound by any two of those values (e.g., from 1.0 mm/s to 2.0 mm/s, from 1.0 mm/s to 5.0 mm/s, and so on).

An anti-resonant hollow core optical fiber (not separately illustrated) can then be drawn from the fiber preform 10 described here, such as the fiber preform 10 made pursuant to the method 100 of the present disclosure.

The fiber preform 10 and the method 100 of the present disclosure address the problems set forth in Background, in a variety of ways. Among them, the use of the interfacial layer 112 in the method 100 of manufacturing avoids the cost and expense of adding a laser emission absorbing metal layer via vapor deposition. The interfacial layer 112 is applied to either the outer preform cladding 18 or inner preform tube 32 (or both) in a more cost-effective manner, such as forming the sinterable coating 126 from the evaporable mixture 130 or the curable mixture 122 and then sintering the sintering coating 126 at the sintering step 132. Both the curable mixture 122 and the evaporable mixture 130 can be applied via syringe injection, brushing, dipping, and so. In short, conventional fiber making equipment can be utilized to manufacture the fiber preform 10. Second, the change in composition resulting from diffusion of the metal layer is also avoided. The interfacial layer 112 is preferably largely silica, as is (in typical embodiments) the outer preform cladding 18 and each of the inner preform tubes 32. Third, the laser 110 used in the method 100 generates the welding emission 108 having peak intensity wavelength in the ultraviolet region. Thus, the residual stress that results from the use of an open flame and CO₂ laser emission is avoided. In typical embodiments, the outer preform cladding 18 and the inner preform tube 32 is made primarily of silica, which does not absorb the welding emission 108 within the ultraviolet range. Only the interface layer 112, with the UV-absorbing oxide does. As a result, the volume of material that is heated by the welding emission 108 during the laser welding step 102 is reduced. Thus, stress developed as a consequence of the laser welding step 102 is rather limited. More limited stress means a reduction in the likelihood of fracture of the fiber preform 10.

### Examples

Example 1 – For Example 1, an evaporable mixture of powderized ULE® as silica with titanium oxide, Hypermer KD-1 as dispersant, polybutylene carbonate as binder, and methyl ethyl ketone as solvent was formed. The evaporable mixture was then deposited as a length of material via syringe onto an outer tube surface of an inner perform tube at both the first tube end and the second tube end to form an evaporable coating thereon. The length of material extended parallel to the tube axis of the inner preform tube. The inner preform tube was made of fused silica.

The outer tube surface with the evaporable coating on both the first tube end and the second tube end was then subjected to a sintering step. More particularly, the outer tube surface was placed in a high temperature furnace set for 1250 °C. As temperature rose, the solvent evaporated and the binder burned out. The temperature was too low to distort the inner preform tube. While exposed to the temperature of 1250 °C, the powderized ULE® densified to form a soot layer extending along a layer length parallel to the tube axis.

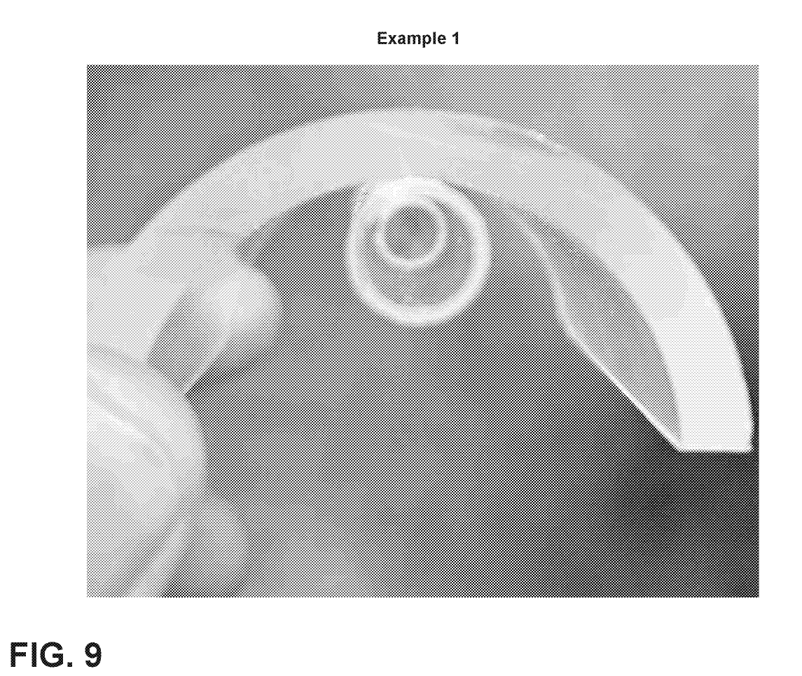

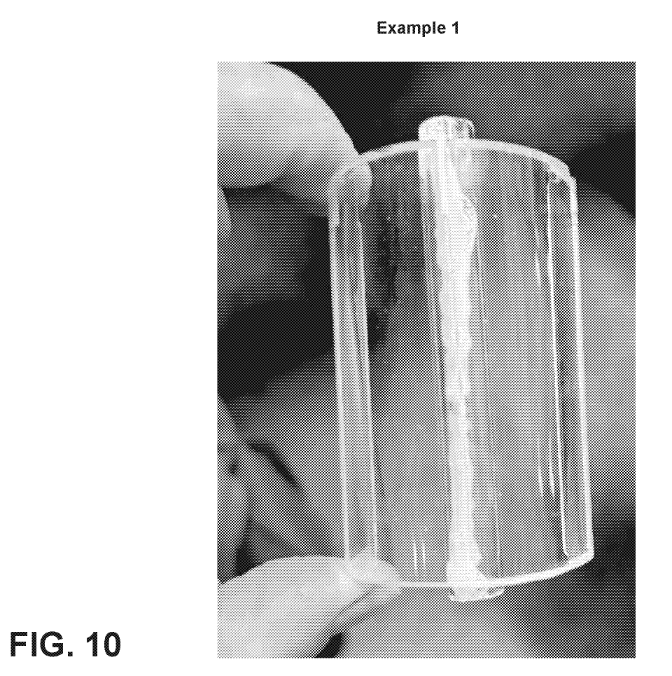

The inner preform tube with the soot layer thereupon was then subjected to an assembly step to bring together the inner preform tube with an outer preform cladding so that the soot layer was sandwiched therebetween. A laser welding step was then conducted simultaneously with a translating step. The average laser power was within a range of from 20 W to 30 W. The translation rate was within a range of from 1 mm/s to 2 mm/s. A laser weld volume fusing the outer preform cladding and the inner preform tube together was formed along a weld length parallel to the tube axis, thus producing a fiber preform. An image of the fiber preform after cross sectioning is reproduced at FIGS. 9-10.

Example 2 – For Example 2, an evaporable mixture like that of Example 1 was deposited onto a block of silica to form an evaporable coating. The block of silica was subjected to a sintering step, like that described in Example 1. The block of silica was then brought together with a block of Corning’s ULE® glass (silica with TiO₂) with the soot layer sandwiched therebetween. A laser welding step was conducted by directing a welding emission from a laser to the soot layer. A laser weld volume resulted fusing the blocks of silica and ULE® together as a welded article.

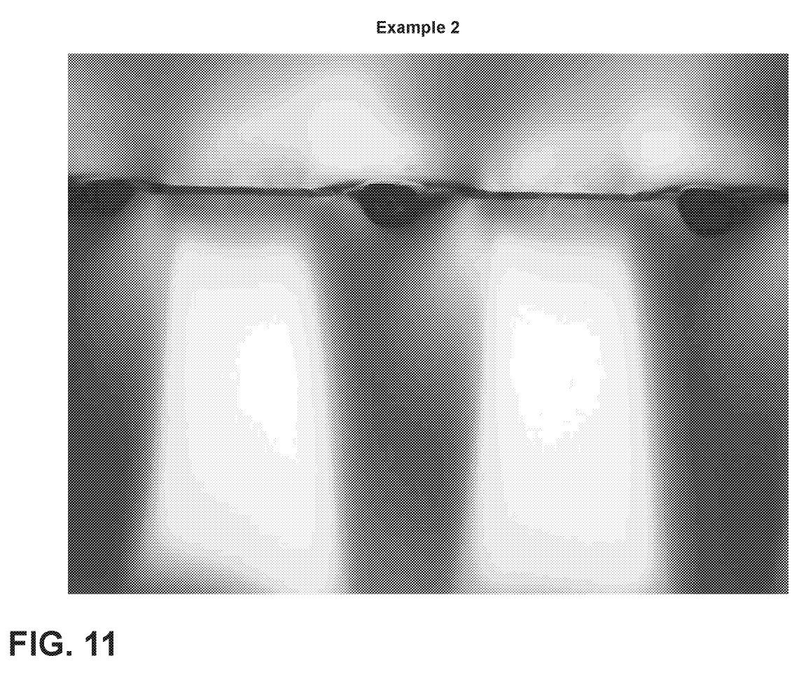

A birefringence image of the welded article was captured. The image is reproduced at FIG. 11. Study of the image, with the block of silica under the block of ULE®, reveals that tensile stress is located away from the interface between the two block. The brighter the area, the more the tensile stress. Because the tensile stress is away from the interface, crack formation is unlikely.

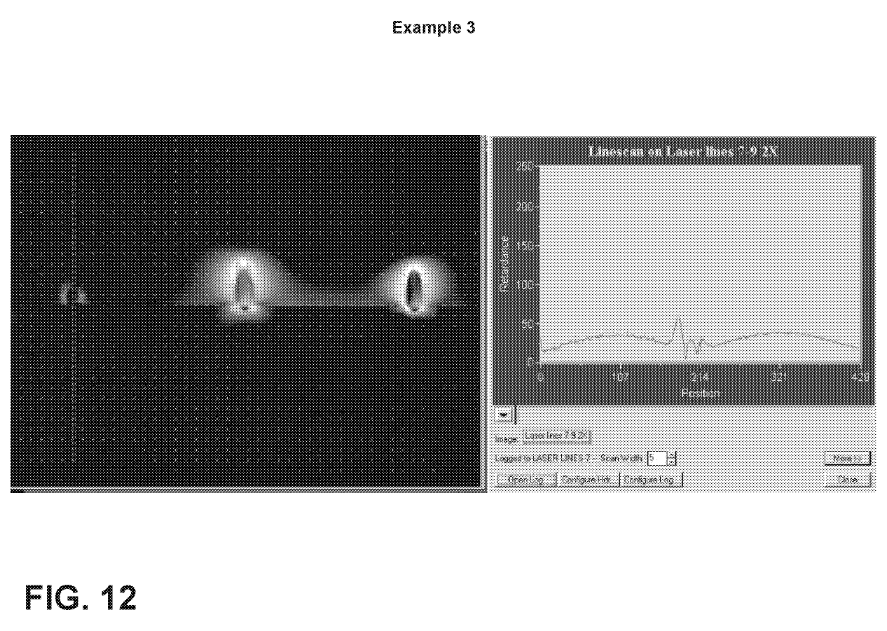

Example 3 – For Example 3, the circumstances were the same as for Example 2, with the exception that both blocks of material were fused silica. A birefringence image of the welded article was captured. The image is reproduced at FIG. 12. Study of the image reveals a peak tensile stress within a range of from 20 MPa to 30 MPa at a distance of less than 500 microns from the interface between the welded blocks. The laser welded volume is readily visible extending from the interface slightly downward into the lower block of silica from the interface but upward to a greater degree into the upper block of silica. The shape of the laser welded volume is indicative of the plasma formation developed increasingly into the welding emission toward the laser as the pulses accumulated.

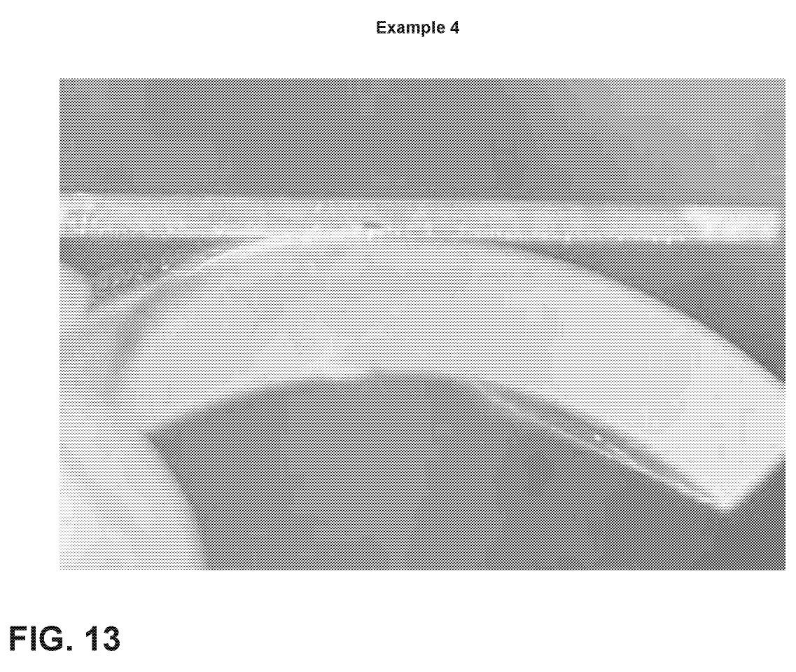

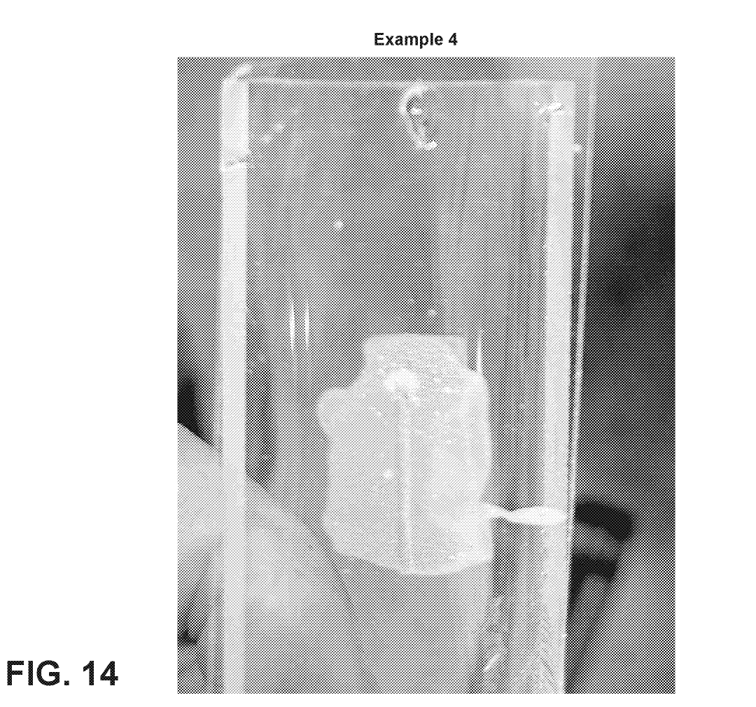

Example 4 – Example 4 is the same as Example 1 with the exceptions that instead of an outer preform cladding, the inner preform tube was fused to a flat piece of silica, and the soot layer was formed on the flat piece of silica rather than the inner preform tube before the assembling step. Images were captured after slicing of the resulting welded article. The images are reproduced at FIGS. 13-14.

It will be apparent to those skilled in the art that various modifications and variations can be made without departing from the spirit or scope of the claims.

What is claimed is:

1. A fiber preform comprising:
a first preform end, a second preform end, and a longitudinal axis extending from the first preform end to the second preform end;
an outer preform cladding through which the fiber longitudinal axis extends, the outer preform cladding comprising an inner cladding surface facing and disposed radially around the longitudinal axis;
inner preform tubes coupled to the outer preform cladding at the inner cladding surface of the outer preform cladding, each of the inner preform tubes comprising (i) a tube axis extending therethrough parallel to the longitudinal axis of the fiber preform, (ii) an inner tube surface extending radially around the tube axis, and (iii) an outer tube surface facing away from the tube axis, and wherein the inner preform tubes collectively defining a preform core that extends radially from the longitudinal axis and that is tangential to the outer tube surface of each of the inner preform tubes; and
first laser weld volumes, each of the first laser weld volumes fusing a different one of the inner preform tubes to the outer preform cladding,
wherein, each of the first laser weld volumes comprises an oxide that exhibits an ultraviolet absorption tail within a range of from 200 nm to 400 nm.

2. The fiber preform of claim 1, wherein the outer preform and each of the inner preform tubes has a composition comprising SiO₂.

3. The fiber preform of claim 1, wherein the oxide is a glass.

4. The fiber preform of claim 3, wherein the glass is silica glass with a dopant, the dopant inducing the ultraviolet absorption tail in the silica glass.

5. The fiber preform of claim 4, wherein the dopant is TiO₂, GeO₂, B₂O₃, P₂O₅, or Al₂O₃.

6. The fiber preform of claim 1, wherein the coefficient of thermal expansion of the oxide is less than or equal to 5 ppb/K at 20°C.

7. The fiber preform of claim 1, wherein the oxide has a thickness within a range of from 1 µm to 300 µm.

8. The fiber preform of claim 1, wherein the fiber preform exhibits a maximum tensile stress of less than or equal to 40 MPa proximate the first laser weld volumes.

9. The fiber preform of claim 1, wherein the ultraviolet absorption tail is within a range of from 300 nm to 400 nm.

10. A method of manufacturing a fiber preform comprising:
a laser welding step comprising directing a welding emission from a laser to an interfacial layer sandwiched between an outer preform cladding of a preform workpiece and an inner preform tube of the preform workpiece,
wherein, the welding emission comprises a wavelength of peak intensity,
wherein, the interfacial layer is more absorptive of the wavelength of peak intensity than both the outer perform cladding and the inner preform tube, and
wherein, during the laser welding step, the absorption of the welding emission by the interfacial layer generates a plasma that increases temperature and reduces viscosity of one or more of the outer preform cladding and the inner preform tube sufficiently for a laser weld volume to form that fuses the outer preform cladding and the inner preform tube together.

11. The method of claim 10, wherein the wavelength of peak intensity of the welding emission is within a range of from 200 nm to 400 nm.

12. The method of claim 10, wherein the interfacial layer is a glass layer or a soot layer.

13. The method of claim 12, wherein the glass layer or the soot layer comprises silica and a dopant, the dopant inducing an ultraviolet absorption tail in the silica, the ultraviolet absorption tail within a range of from 200 nm to 400 nm.

14. The method of claim 13, wherein the dopant is one or more of TiO₂, GeO₂, Al₂O₃, P₂O₅, and B₂O₃.

15. The method of claim 14, wherein the glass layer or the soot layer comprises (i) TiO₂ within a range of from 1.0 wt% to 20.0 wt% and (ii) silica within a range of from 80.0 wt% and 99 wt%.

16. The method of claim 10, further comprising:
a curable coating step preceding the laser welding step, the curable coating step comprising coating a curable mixture onto one or more of an outer tube surface of the inner preform tube and an inner cladding surface of the outer preform cladding to form a curable coating, the curable mixture comprising a precursor of the interfacial layer in a powder form and an ultraviolet-curable adhesive;
a curing step comprising directing ultraviolet electromagnetic radiation onto the curable coating disposed upon the one or more of the outer tube surface and the inner cladding surface to form a sinterable layer; and
a sintering step comprising subjecting the sinterable layer, while disposed upon the one or more of the outer tube surface and the inner cladding surface, to a sintering temperature to form the interfacial layer.

17. The method of claim 10, further comprising:
an evaporable coating step preceding the laser welding step, the evaporable coating step comprising coating an evaporable mixture onto one or more of an outer tube surface of the inner preform tube and an inner cladding surface of the outer preform cladding to form a sinterable layer, the evaporable mixture comprising a precursor of the interfacial layer in a powder form, a dispersant, a binder, and a solvent; and
a sintering step comprising subjecting the sinterable layer to a sintering temperature while disposed upon the one or more of the outer tube surface and the inner cladding surface, thus forming the soot layer.

18. The method of claim 10, further comprising:
an assembly step comprising bringing the outer preform cladding and the inner preform tube together so that the interfacial layer is sandwiched therebetween, thus forming the preform workpiece.

19. The method of claim 10, wherein during the laser welding step, the laser emits the welding emission with an average power within a range of from 2 W to 60 W and as pulses with a frequency of less than 5 MHz and a pulse duration within a range of from 1 ps to 20 ns.

20. An anti-resonant hollow core optical fiber drawn from the fiber preform of claim 1 or from a fiber preform made pursuant to the method of claim 10.
